(19) United States
(12) Patent Application Publication
(10) Pub. No.: US 2012/0204351 A1
(43) Pub. Date: Aug. 16, 2012

(54) X-RAYABLE PATIENT POSITIONING PLATE

(75) Inventors: Rolf Revenus, Kuppenheim (DE); Holger Dörr, Rastatt (DE)

(73) Assignee: Maquet GmbH & Co. KG, Rastatt (DE)

(21) Appl. No.: 13/369,478

(22) Filed: Feb. 9, 2012

(30) Foreign Application Priority Data
Feb. 11, 2011 (DE) 20 2011 000 319.1

(51) Int. Cl. A61G 13/12

(52) U.S. Cl. 5/648; 5/630

(57) ABSTRACT

In an X-rayable patient positioning plate with an outer shell, enclosing a hollow space filled with filler material, the shell consists of a tub-like upper part (36) and a tub-like lower part (38), each having a tub floor (40, 42) forming the plate top side and the plate bottom side, respectively, which forms with the tub margin (44, 46) an inner angle of more than 90°, while the top part (36) and the bottom part (38) are dimensioned and fitted into each other such that the tub margins (44, 46) of the two parts (36, 38) lie flat against each other and their tub floors (40, 42) bound the hollow space of the shell between them.

### CROSS REFERENCE TO RELATED APPLICATIONS

Applicant hereby claims foreign priority benefits under U.S.C. §119 from German Utility Model Application No. 20 2011 000 319.1 filed on Feb. 11, 2011, the contents of which are incorporated by reference herein.

### TECHNICAL FIELD

The invention concerns an X-rayable patient positioning plate with an outer shell, enclosing a hollow space filled with filler material.

### BACKGROUND OF THE INVENTION

Presentday operation tables in orthopedics often have plates firmly connected to the supporting structure of the table for the positioning of the patient. Problems keep occurring during the irradiation of these plates, partly due to the design of the plates themselves or their fastening to the supporting structure of the operating table.

### SUMMARY OF THE INVENTION

The underlying problem of the invention is to indicate an X-rayable patient positioning plate of the kind mentioned above, which on the one hand assures a stable and comfortable positioning of the patient and on the other hand hinders as little as possible the X-raying of the patient lying on the positioning plate.

This problem is solved according to the invention in that the shell consists of a tub-like upper part and a tub-like lower part, each having a tub floor forming the plate top side and the plate bottom side, respectively, and a tub margin forming an inner angle with the tub floor of more than 90°, and the top part and the bottom part are dimensioned and fit into each other such that the tub margins of the two parts lie flat against each other and their tub floors bound the hollow space of the shell between them. Thus, the top part reaches around the bottom part and sits with the inner surface of its tub margin on the outer surface of the tub margin of the lower part. The resulting patient positioning plate therefore has rooflike sloping margin surfaces in cross section, which on the one hand afford more comfort in the positioning of the patient and on the other hand avoid a material buildup during the X-raying of the patient positioning plate. In the entire plate region the path traveled by the X-rays inside the shell material is practically always equal only to twice the wall thickness of the shell. If the shell were formed in the shape of a flat cuboid box, the path of the X-rays traveling inside the shell material would correspond to the plate thickness in the margin region of the shell, so that in this region the plate can cause definite shadows in the X-ray image.

If the patient positioning plate is to be used as a pelvic positioning plate, it advisedly has at least approximately the shape of an equilateral triangle, so that the broad base of the triangle is available to support the pelvis of the patient, while the patient's legs lie free toward the vertex of the triangle.

Advisedly, the patient positioning plate is configured so that it is easily interchangeable. For this, the patient positioning plate has recesses near its edges to receive holding elements, which are arranged on support stringers of the supporting structure of the operating table. These recesses, for example, can comprise slots, in which the holding elements fashioned as headed bolts engage, so that the patient positioning plate can be suspended from the support stringers of the supporting structure of the operating table without having to arrange metallic fastening elements on the patient positioning plate itself.

Preferably the shell parts, i.e., the top part and the bottom part, consist of a fiber composite, such as carbon fiber-reinforced plastic, while the hollow space of the shell is filled with a foam, such as high-resistance foam. In this way, one obtains a stable-shape, highly durable positioning plate that is X-rayable and can be easily replaced.

### BRIEF DESCRIPTION OF THE DRAWINGS

The following description in connection with the enclosed drawings explains the invention by means of a sample embodiment. There are shown:

FIG. 1, a partly schematic perspective representation of part of a patient positioning plate for an orthopedic operating table,

FIG. 2, an enlarged representation of the design detail indicated by A in FIG. 1, and

FIG. 3, a section through the pelvic positioning plate along line III-III in FIG. 1.

### DETAILED DESCRIPTION OF THE PREFERRED EMBODIMENT

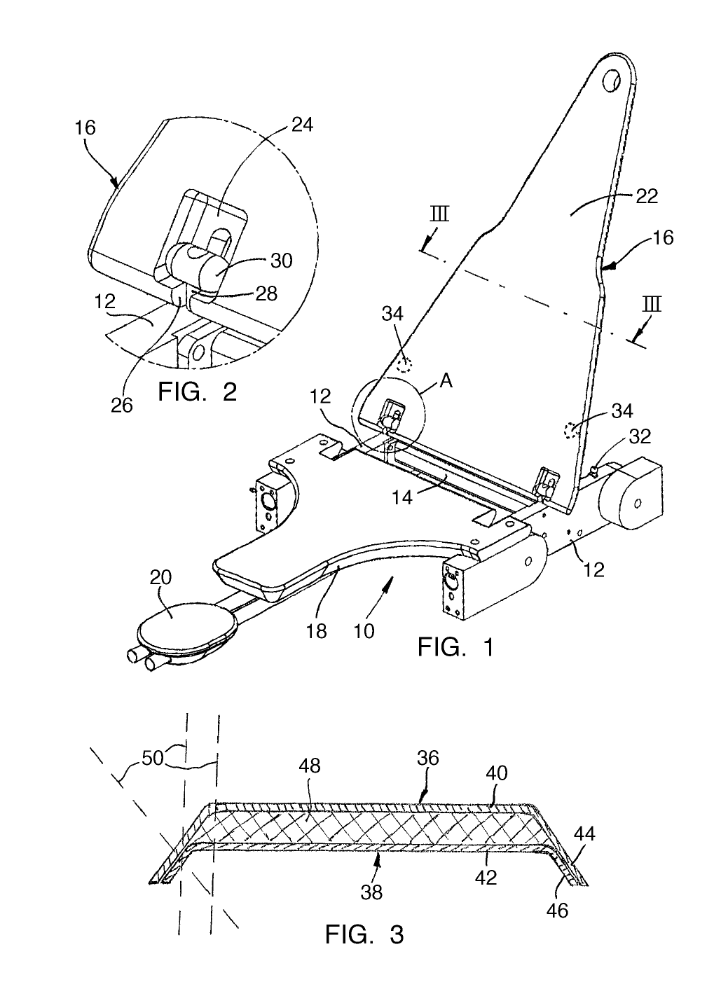

The patient positioning surface represented in FIG. 1, generally designated by 10, comprises two support stringers 12, joined to each other by cross braces 14, and on which a pelvic positioning plate 16, a back positioning plate 18 and a head plate 20 are arranged. The pelvic positioning plate 16 has approximately the shape of an equilateral triangle and is detachably connected to the support stringers 12 near the base of the triangle. For this, two trough-shaped recesses 24 open toward the plate top side 22 are provided in the pelvic positioning plate 16 near the base of the triangle, each of them having a receiving slot 26 open toward the base of the plate. This receiving slot 26 can engage with the shaft 28 of a head bolt, connected to one of the support stringers 12, whereupon its head 30 will lie in the trough 24 of the positioning plate 22 (FIG. 2). In the folded-up position shown in FIG. 1, the pelvic positioning plate 16 can be shoved by the receiving slots 26 onto the shafts 28 of the two head bolts and then be folded down, so that it lies in the same plane as the back plate 18. Two additional bolts 32 engage with the support stringers 12 each in an opening 34 provided at the bottom side of the pelvic positioning plate 16. In the folded-down state, therefore, the pelvic positioning plate cannot be shifted. It is held in this position by the weight of the patient lying on it. The above description shows that the plate can be quickly replaced in this manner, without having to loosen and tighten any locking means.

The construction of the patient positioning plate 16 can be seen from FIG. 3. The plate consists of a shape-stable tub-like top part 36 and a tub-like shape-stable bottom part 38, which together form the outer shell of the positioning plate 16. Each of these tubs has a tub floor 40 and 42, and a tub margin 44 and 46 that is inclined outward relative to these. The two tub-like parts 36 and 38 are dimensioned and fitted into each other so that their tub margins 44 and 46 lie flat against each other and the tub floors 40 and 42 enclose a hollow space between them, which is filled with a foam 48.

As can be seen from FIG. 3, this construction of the patient positioning plate 16 means that, during X-raying, the X-rays 50 travel a path in the relatively dense shell material that corresponds basically to no more than twice the wall thickness of the shell. In this way, one obtains a uniform attenuation of the X-rays over the entire surface of the plate.

While the present invention has been illustrated and described with respect to a particular embodiment thereof, it should be appreciated by those of ordinary skill in the art that various modifications to this invention may be made without departing from the spirit and scope of the present.

What is claimed is:

1. An x-rayable patient positioning plate with an outer shell, enclosing a hollow space filled with filler material, wherein the shell consists of a tub-like upper part and a tub-like lower part, each having a tub floor forming the plate top side and the plate bottom side, respectively, which forms with the tub margin an inner angle of more than 90°, and the top part and the bottom part are dimensioned and fitted into each other such that the tub margins of the two parts lie flat against each other and their tub floors bound the hollow space of the shell between them.

2. The X-rayable patient positioning plate according to claim 1, wherein it is configured as a pelvic positioning plate and has at least approximately the shape of an equilateral triangle.

3. The X-rayable patient positioning plate according to claim 1, wherein the patient positioning plate has recesses near its edges to receive holding elements, which are arranged on support stringers of a patient positioning surface.

4. The X-rayable patient positioning plate according to claim 1, wherein the top part and the bottom part of the shell consist of a fiber composite.

5. The X-rayable patient positioning plate according to claim 1, wherein the filler consists of foam, especially a high-resistance plastic foam.

6. The X-rayable patient positioning plate according to claim 2, wherein the patient positioning plate has recesses near its edges to receive holding elements, which are arranged on support stringers of a patient positioning surface.

7. The X-rayable patient positioning plate according to claim 2, wherein the top part and the bottom part of the shell consist of a fiber composite.

8. The X-rayable patient positioning plate according to claim 3, wherein the top part and the bottom part of the shell consist of a fiber composite.

9. The X-rayable patient positioning plate according to claim 2, wherein the filler consists of foam, especially a high-resistance plastic foam.

10. The X-rayable patient positioning plate according to claim 3, wherein the filler consists of foam, especially a high-resistance plastic foam.

11. The X-rayable patient positioning plate according to claim 4, wherein the filler consists of foam, especially a high-resistance plastic foam.
